(19) United States
(12) Patent Application Publication
(10) Pub. No.: US 2006/0033705 A1
(43) Pub. Date: Feb. 16, 2006

(54) Mouse pointer controlling apparatus and method

(76) Inventors: Hyuk Jeong, Daejeon-city (KR); Jong Sung Kim, Daejeon-city (KR); Wookho Son, Daejeon-city (KR); Hyun Bin Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/059,724

(22) Filed: Feb. 15, 2005

(30) Foreign Application Priority Data
Aug. 11, 2004 (KR) 10-2004-0063095

(51) Int. Cl. G09G 5/00

(52) U.S. Cl. 345/156

(57) ABSTRACT

A mouse pointer controlling apparatus and method are provided. The mouse pointer controlling apparatus includes: a mouse pointer direction determination unit, which issues a command to rotate a mouse pointer clockwise in response to a first signal and issues a command to rotate the mouse pointer counterclockwise in response to a second signal; and a mouse pointer movement unit, which issues a command to move the mouse pointer in the same direction as the mouse pointer heads toward if the first and second signals are simultaneously generated. Accordingly, it is possible to control the mouse pointer using only two switches.

### BACKGROUND OF THE INVENTION

This application claims the benefit of Korean Patent Application No. 10-2004-0063095, filed on Aug. 11, 2004, in the Korean Intellectual Property Office, the disclosure of which is incorporated herein in its entirety by reference.

1. Field of the Invention

The present invention relates to a mouse pointer controlling apparatus and method, and more particularly, to a mouse pointer controlling apparatus and method using only a predetermined number of switches.

2. Description of the Related Art

A keyboard and a mouse are generally used as input devices for a computer. In order to efficiently move a mouse pointer on a screen of a computer, a user should place a conventional mouse device on a flat surface. Accordingly, the conventional mouse device is not suitable for controlling the location of a mouse pointer on a screen of a wearable computer, such as a personal digital assistant (PDA), which is considered as a next-generation computer. In addition, there is a clear limit in applying a conventional mouse pointer controlling method using a joystick or trackball to a wearable computer because the conventional mouse pointer controlling method requires a user to keep holding a joystick or trackball in his or her hand while using the joystick or trackball.

A conventional trackball mouse device, which is designed to be used in a portable computer, is disclosed in Korean Patent Gazette No. 1997-8016. In order to use the conventional trackball mouse device, a user is required to keep holding it or to attach it to his or her body. However, the conventional trackball mouse device is relatively large, and thus, it may be rather inconvenient for the user to carry it.

### SUMMARY OF THE INVENTION

The present invention provides a mouse pointer controlling apparatus and method used in a portable computer environment.

According to an aspect of the present invention, there is provided a mouse pointer controlling apparatus including: a mouse pointer direction determination unit, which issues a command to rotate a mouse pointer clockwise in response to a first signal and issues a command to rotate the mouse pointer counterclockwise in response to a second signal; and a mouse pointer movement unit, which issues a command to move the mouse pointer in the same direction as the mouse pointer heads toward if the first and second signals are simultaneously generated.

According to another aspect of the present invention, there is provided a mouse pointer controlling method including: issuing a command to rotate a mouse pointer clockwise in response to a first signal and issues a command to rotate the mouse pointer counterclockwise in response to a second signal; and issuing a command to move the mouse pointer in the same direction as the mouse pointer heads toward if the first and second signals are simultaneously generated.

According to the present invention, it is possible to control a mouse pointer using only two switches.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a mouse pointer controlling apparatus according to an exemplary embodiment of the present invention;

FIG. 2 is a diagram illustrating the controlling of a mouse pointer according to an exemplary embodiment of the present invention;

FIG. 3A is a diagram illustrating an example of one of the switches of the mouse pointer controlling apparatus of FIG. 1;

FIG. 3B is a diagram illustrating an example of the mouse pointer controlling apparatus of FIG. 1 that is worn on a user's hand; and

FIGS. 4A and 4C are flowcharts of a mouse pointer controlling method according to an exemplary embodiment of the present invention.

### DETAILED DESCRIPTION OF THE INVENTION

The present invention will now be described more fully with reference to the accompanying drawings in which exemplary embodiments of the invention are shown.

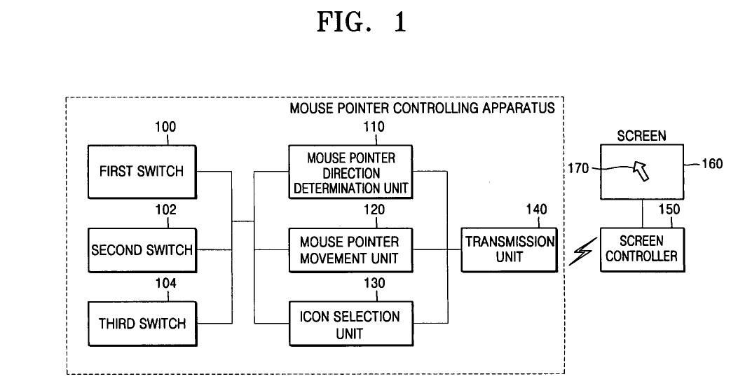

FIG. 1 is a block diagram of a mouse pointer controlling apparatus according to an exemplary embodiment of the present invention. Referring to FIG. 1, the mouse pointer controlling apparatus includes a plurality of switches, i.e., first, second, and third switches 100, 102, and 104, a mouse pointer direction determination unit 110, a mouse pointer movement unit 120, an icon selection unit 130, and a transmission unit 140. The mouse pointer controlling apparatus is connected to a screen controller 150 in a wireless or wired manner.

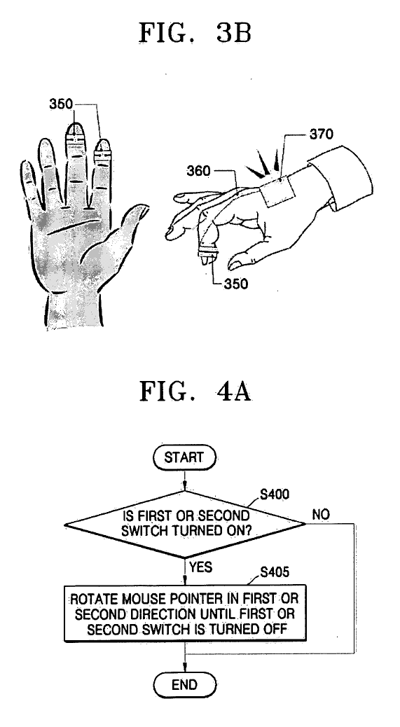

The mouse pointer controlling apparatus needs at least two switches to control a mouse pointer. Each of the switches may be formed as a ring, as illustrated in FIG. 3A, in which case, a user can easily wear the switches on his or her fingers. Alternatively, each of the switches may be formed to have a shape other than a ring shape. For example, the switches may be formed on a thin rectangular plate, and then a resulting structure may be attached to a user's bag or clothes. Each of the switches may be formed in various shapes other than those mentioned herein.

If the first switch 100 is turned on, the mouse pointer direction determination unit 110 issues a command to rotate a mouse pointer 170 counterclockwise at uniform velocity until the first switch 100 is turned off. If the second switch 102 is turned on, the mouse pointer direction determination unit 110 issues a command to rotate the mouse pointer 170 clockwise at uniform velocity until the second switch 102 is turned off. The rotation speed of the mouse pointer 170 may be set based on a user's preference.

The first, second, and third switches 100, 102, and 104 may be realized as physical devices. Alternatively, different patterns of bio-signals, such as brainwave or electromyogram signals, may serve as the first, second, and third switches 100, 102, and 104.

Therefore, if the mouse pointer direction determination unit 110 receives a first bio-signal from a user, it issues the command to rotate the mouse pointer 170 counterclockwise as if the first switch 100 is turned on. If the mouse pointer direction determination unit 110 receives a second bio-signal from the user, it issues the command to rotate the mouse pointer 170 clockwise as if the second switch 102 is turned on.

In short, examples of the first, second, and third switches 100, 102, and 104 include hardware devices and bio-signals, such as brainwave or electromyogram signals.

If the first and second switches 100 and 102 are both turned on, the mouse pointer movement unit 120 issues a command to move the mouse pointer 170 in the same direction as the mouse pointer 170 heads towards until the first and second switches 100 and 102 are both turned off. In the case of using bio-signals instead of the first, second, and third switches 100, 102, and 104, the mouse pointer movement unit 120 issues the command to move the mouse pointer 170 in the same direction as the mouse pointer 170 heads toward when it receives a third signal, which is different from the first and second bio-signals.

If the first or second switch 100 or 102 is double-clicked in the same manner as a typical mouse, the icon selection unit 130 issues a command to select an icon on which the mouse pointer 170 is currently located.

The mouse pointer controlling apparatus may include more than three switches having predetermined functions.

The transmission unit 140 transmits the commands issued by the mouse pointer direction determination unit 110, the mouse pointer movement unit 120, and the icon selection unit 130 to the screen controller 150. Preferably, but not necessarily, the transmission unit 140 transmits the commands issued by the mouse pointer direction determination unit 110, the mouse pointer movement unit 120, and the icon selection unit 130 to the screen controller 150 using a wireless communication method, such as an infrared ray communication method, a Bluetooth-based communication method, or a radio frequency (RF) communication method.

The screen controller 150 may rotate and/or move the mouse pointer 170 on a screen 160 and select an icon pointed at by the mouse pointer 170 based on the commands received from the transmission unit 140.

As described above, the mouse pointer controlling apparatus according to the exemplary embodiment of the present invention can control the location of the mouse pointer 170 or select an icon pointed at by the mouse pointer 170 using at least two switches.

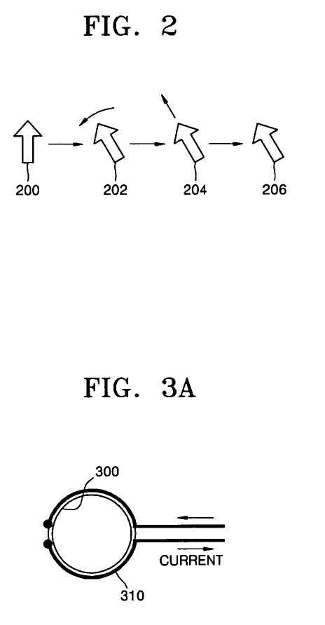

FIG. 2 is a diagram illustrating the controlling of the mouse pointer 170. Referring to FIG. 2, the mouse pointer 170 is designed as an arrow so that a user can easily notice a direction that the mouse pointer 170 heads toward and the degree to which the mouse pointer 170 rotates.

For example, if the first switch 100 is turned on, the mouse pointer 170 rotates counterclockwise, as shown by reference numeral 202, until the first switch 100 is turned off. If the first switch 100 is turned off, the mouse pointer 170 stops rotating. If the first and second switches 100 and 102 are all turned on, the mouse pointer 170 moves in the same direction as it heads towards, as shown by reference numeral 204, until the first and second switches 100 and 102 are all turned off. If the first and second switches 100 and 102 are all turned off, the mouse pointer 170 stops moving. If the first or second switch 100 or 102 is double-clicked with the mouse pointer 170 placed on a predetermined icon, as shown by reference numeral 206, the predetermined icon is selected.

FIG. 3A is a diagram illustrating an example of one of the first and second switches 100 and 102 of the mouse pointer controlling apparatus of FIG. 1. Referring to FIG. 3A, a switch may be formed as a ring 300 so that a user can easily wear the switch on his or her finger. In order to turn on or off an electric current, a wire 310 is attached to the ring 300 leaving only a portion of the ring 300 unwired. In addition, the wire 310 is connected to the user's skin so that an electric current flows between the switch and the user's skin through the wire 310. In short, the switch may be designed based on the fact that human skin may serve as a conductor.

For example, the first and second switches 100 and 102 of FIG. 1 may be formed to have the same structure as illustrated in FIG. 3A and then may be worn on the user's index and middle fingers, respectively. Preferably, but not necessarily, the user wears the first and second switches 100 and 102 on his or her index and middle fingers, respectively, with unwired portions of the first and second switches 100 and 102 placed on the bottom of the respective fingers so that he or she can easily touch the unwired portions of the first and second switches with his or her thumb.

FIG. 3B is a diagram illustrating an example of the mouse pointer controlling apparatus of FIG. 1 that is worn on a user's hand. Referring to FIGS. 1 and 3B, switches 350 are worn on a user's index and middle fingers, and a controller 370, which comprises the mouse pointer direction determination unit 110, the mouse pointer movement unit 120, the icon selection unit 130, and the transmission unit 140, is attached to the back of the user's hand. The switches 350 are connected to the controller 370 via wires 360.

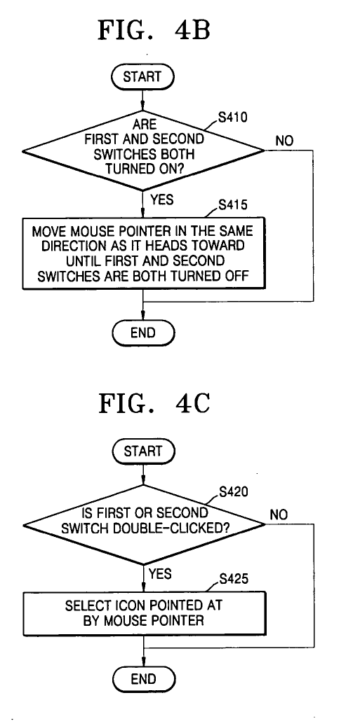

FIGS. 4A through 4C are flowcharts of a mouse pointer controlling method according to an exemplary embodiment of the present invention. Specifically, FIG. 4A is a flowchart of a method of controlling the rotation of a mouse pointer according to an exemplary embodiment of the present invention. Referring to FIGS. 1 and 4A, if the first or second switch 100 or 102 is turned on in operation S400, the mouse pointer direction determination unit 110 issues a command to rotate the mouse pointer 170 in a first or second direction (e.g., clockwise or counterclockwise) until the first or second switch 100 or 102 is turned off, in operation S405.

FIG. 4B is a flowchart of a method of controlling the movement of a mouse pointer according to an exemplary embodiment of the present invention. Referring to FIGS. 1 and 4B, if the first and second switches 100 and 102 are both turned on in operation S410, the mouse pointer movement unit 120 issues a command to move the mouse pointer 170 in the same direction as the mouse pointer 170 heads toward until the first and second switches 100 and 102 are both turned off, in operation S415.

FIG. 4C is a flowchart of a method of selecting an icon pointed at by a mouse pointer according to an exemplary embodiment of the present invention. Referring to FIGS. 1 and 4C, if the first or second switch 100 or 102 is double-clicked or the third switch 104 is turned on in operation S420, the icon selection unit 130 issues a command to select an icon currently pointed at by the mouse pointer 170 in operation S425.

The transmission unit 140 transmits the command issued in operation S405, S415, or S425 to the screen controller 150 of a computer that directly controls the screen 160. Then, the screen controller 150 rotates or moves the mouse pointer 170 on the screen 160 or selects an icon currently pointed at by the mouse pointer 170 in response to the command received from the transmission unit 140.

As described above, the mouse pointer controlling apparatus according to the present invention can help a user effectively control a mouse pointer using only two switches. Since the switches can be formed as rings, the user can easily wear them on his or her fingers and can easily control the mouse pointer even in a portable computing environment. In addition, since the switches can be realized as bio-signals, even disabled people can easily control the mouse pointer.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A mouse pointer controlling apparatus comprising:
a mouse pointer direction determination unit, which issues a command to rotate a mouse pointer clockwise in response to a first signal and issues a command to rotate the mouse pointer counterclockwise in response to a second signal; and
a mouse pointer movement unit, which issues a command to move the mouse pointer in the same direction as the mouse pointer heads toward if the first and second signals are simultaneously generated.

2. The mouse pointer controlling apparatus of claim 1 further comprising:
a first switch, which is formed as an open ring and generates the first signal based on whether the open ring stays open or is closed; and
a second switch, which is formed as an open ring and generates the second signal based on whether the open ring stays open or is closed.

3. The mouse pointer controlling apparatus of claim 2, wherein the first and second switches are worn on a user's fingers and generate the first and second signals, respectively, when the user closes them with his or her thumb.

4. The mouse pointer controlling apparatus of claim 1 further comprising:
a transmission unit, which transmits the commands issued by the mouse pointer direction determination unit and the mouse pointer movement unit to a screen controller that controls the mouse pointer on a screen.

5. The mouse pointer controlling apparatus of claim 1 further comprising:
an icon selection unit, which selects an icon pointed at by the mouse pointer if one of the first and second signals is generated twice within a predetermined period of time.

6. The mouse pointer controlling apparatus of claim 1 further comprising:
a third switch, which is formed as an open ring and generates a third signal based on whether the open ring is open or closed; and
an icon selection unit, which selects an icon pointed at by the mouse pointer if the third signal is generated.

7. The mouse pointer controlling apparatus of claim 1, wherein the first and second signals are bio-signals including brainwave and electromyogram signals.

8. A mouse pointer controlling method comprising:
issuing a command to rotate a mouse pointer clockwise in response to a first signal and issues a command to rotate the mouse pointer counterclockwise in response to a second signal; and
issuing a command to move the mouse pointer in the same direction as the mouse pointer heads toward if the first and second signals are simultaneously generated.

9. The mouse pointer controlling method of claim 8 further comprising:
transmitting the issued commands to a screen controller that controls the mouse pointer on a screen.

10. The mouse pointer controlling method of claim 8 further comprising:
selecting an icon pointed at by the mouse pointer if one of the first and second signals is generated twice within a predetermined period of time.

11. The mouse pointer controlling method of claim 8 further comprising:
generating a third signal; and
selecting an icon pointed at by the mouse pointer if the third signal is generated.

12. The mouse pointer controlling method of claim 8, wherein the first and second signals are bio-signals including brainwave and electromyogram signals.
